(19) United States
(12) Patent Application Publication
(10) Pub. No.: US 2012/0206381 A1
(43) Pub. Date: Aug. 16, 2012

(54) ELECTRONIC DEVICE AND METHOD OF CONTROLLING SAME

(75) Inventors: Stanislav PEREVERZEV, Cuptertino, CA (US); Mykola GOLOVCHENKO, Sunnyvale, CA (US)

(73) Assignee: RESEARCH IN MOTION LIMITED, Waterloo (CA)

(21) Appl. No.: 13/173,057

(22) Filed: Jun. 30, 2011

Related U.S. Application Data
(60) Provisional application No. 61/441,722, filed on Feb. 11, 2011.

(51) Int. Cl. G06F 3/041

(52) U.S. Cl. 345/173

(57) ABSTRACT

A method includes displaying information in a display area of a touch-sensitive display, receiving touch data from the display area and touch data from a non-display area where information is not displayed, and determining a touch location in the display area based on the touch data from the display area and the touch data from the non-display area.

### CROSS-REFERENCE TO RELATED APPLICATIONS

This application claims the benefit of U.S. Provisional Patent Application 61/441,722, filed Feb. 11, 2011, the entire content of which is incorporated herein by reference.

### FIELD OF TECHNOLOGY

The present disclosure relates to electronic devices including, but not limited to, electronic devices having displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include several types of devices including mobile stations such as simple cellular telephones, smart telephones (smart phones), Personal Digital Assistants (PDAs), tablet computers, and laptop computers, with wireless network communications or near-field communications connectivity such as Bluetooth® capabilities.

Portable electronic devices such as PDAs, or tablet computers are generally intended for handheld use and ease of portability. Smaller devices are generally desirable for portability. A touch-sensitive display, also known as a touchscreen display, is particularly useful on handheld devices, which are small and may have limited space for user input and output. The information displayed on the display may be modified depending on the functions and operations being performed.

Improvements in electronic devices with displays are desirable.

### BRIEF DESCRIPTION OF THE DRAWINGS

FIG. 1 is a block diagram of a portable electronic device in accordance with an example embodiment.

FIG. 2 is a front view of an example of a portable electronic device in accordance with the disclosure.

FIG. 3 illustrates an example of touch sensors and a touch on the touch-sensitive display of the portable electronic device.

FIG. 4 is a flowchart illustrating a method of controlling the portable electronic device in accordance with the disclosure.

FIG. 5 illustrates another example of a portable electronic device.

### DETAILED DESCRIPTION

The following describes an electronic device and a method that includes displaying information in a display area of a touch-sensitive display, receiving touch data from the display area and touch data from a non-display area where information is not displayed, and determining a touch location in the display area based on the touch data from the display area and the touch data from the non-display area.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to an electronic device, which is a portable or non-portable electronic device in the embodiments described herein. Examples of portable electronic devices include mobile, or handheld, wireless communication devices such as pagers, cellular phones, cellular smart-phones, wireless organizers, personal digital assistants, wirelessly enabled notebook computers, tablet computers, mobile internet devices, and so forth. The portable electronic device may be a portable electronic device without wireless communication capabilities, such as handheld electronic games, digital photograph albums, digital cameras, media players, e-book readers, and so forth. Examples of non portable electronic devices include desktop computers, electronic white boards, smart boards utilized for collaboration, built-in monitors or displays in furniture or appliances, and so forth.

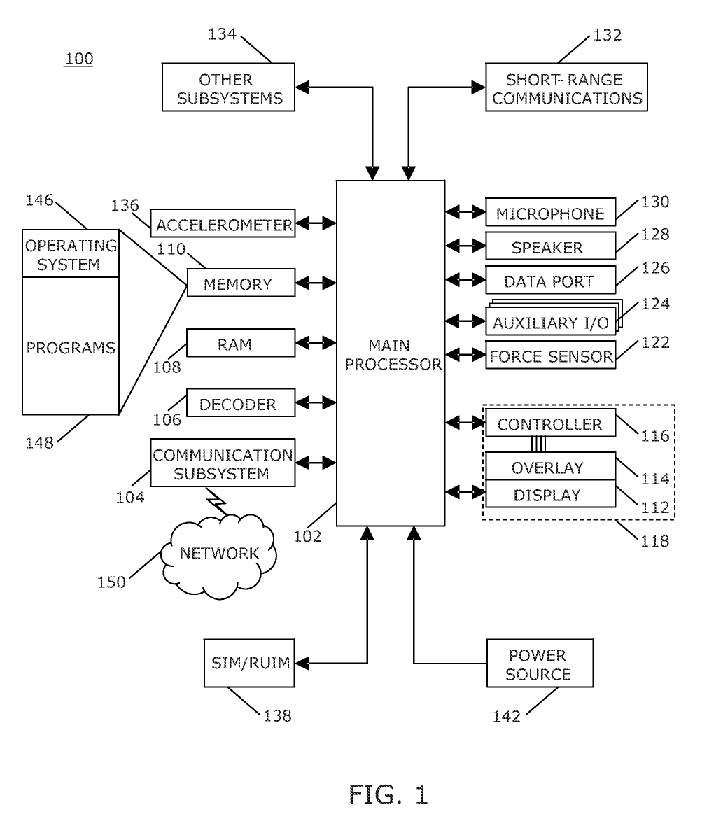

A block diagram of an example of an electronic device 100 is shown in FIG. 1. The electronic device 100, which may be a portable electronic device, includes multiple components, such as a processor 102 that controls the overall operation of the electronic device 100. The electronic device 100 presently described optionally includes a communication subsystem 104 and a short-range communications 132 module to perform various communication functions, including data and voice communications. Data received by the electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the electronic device 100.

The processor 102 interacts with other components, such as Random Access Memory (RAM) 108, memory 110, a display 112 with a touch-sensitive overlay 114 operably connected to an electronic controller 116 that together comprise a touch-sensitive display 118, one or more actuators 120, one or more force sensors 122, an auxiliary input/output (I/O) subsystem 124, a data port 126, a speaker 128, a microphone 130, short-range communications 132, and other device subsystems 134. User-interaction with a graphical user interface is performed through the touch-sensitive overlay 114. The processor 102 interacts with the touch-sensitive overlay 114 via the electronic controller 116. Information, such as text, characters, symbols, images, icons, and other items that may be displayed or rendered on an electronic device, is displayed on the touch-sensitive display 118 via the processor 102. The processor 102 may interact with an orientation sensor such as an accelerometer 136 to detect direction of gravitational forces or gravity-induced reaction forces, for example, to determine the orientation of the electronic device 100.

To identify a subscriber for network access, the electronic device 100 may optionally use a Subscriber Identity Module or a Removable User Identity Module (SIM/RUIM) card 138 for communication with a network, such as the wireless network 150. Alternatively, user identification information may be programmed into memory 110.

The electronic device 100 includes an operating system 146 and software programs or components 148 that are executed by the processor 102 and are typically stored in a persistent, updatable store such as the memory 110. Additional applications or programs may be loaded onto the electronic device 100 through the wireless network 150, the auxiliary I/O subsystem 124, the data port 126, the short-range communications subsystem 132, or any other suitable subsystem 134.

A received signal, such as a text message, an e-mail message, or web page download, is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104, for example.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. A capacitive touch- sensitive display includes a capacitive touch-sensitive overlay 114. The overlay 114 may be an assembly of multiple layers in a stack which may include, for example, a substrate, a ground shield layer, a barrier layer, one or more electrode layers separated by a substrate or other barrier, and a cover. The capacitive touch sensor layers may be any suitable material, such as patterned indium tin oxide (ITO).

The display 112 of the touch-sensitive display 118 includes a display area in which information may be displayed, and a non-display area extending around the periphery of the display area. Information is not displayed in the non-display area, which is utilized to accommodate, for example, electronic traces or electrical connections, adhesives or other sealants, and/or protective coatings around the edges of the display area.

One or more touches, also known as touch contacts or touch events, may be detected by the touch-sensitive display 118. The processor 102 may determine attributes of the touch, including a location of a touch. Touch location data may include data for an area of contact, referred to as a touch area, or data for a single point of contact, such as a point at or near a center of the area of contact. A touch may be detected from any suitable input member, such as a finger, thumb, appendage, or other objects, for example, a stylus, pen, or other pointer, depending on the nature of the touch-sensitive display 118. The controller 116 and/or the processor 102 may detect a touch by any suitable contact member on the touch-sensitive display 118. Multiple simultaneous touches may be detected.

One or more gestures may also be detected by the touch-sensitive display 118. A gesture, such as a swipe, also known as a flick, is a particular type of touch on a touch-sensitive display 118 and may begin at an origin point and continue to an end point. A gesture may be identified by attributes of the gesture, including the origin point, the end point, the distance traveled, the duration, the velocity, and the direction, for example. A gesture may be long or short in distance and/or duration. Two points of the gesture may be utilized to determine a direction of the gesture. A gesture may also include a hover. A hover may be a touch at a location that is generally unchanged over a period of time or is associated with the same selection item for a period of time.

An optional force sensor 122 or force sensors may be disposed in any suitable location, for example, between the touch-sensitive display 118 and a back of the electronic device 100 to detect a force imparted by a touch on the touch-sensitive display 118. The force sensor 122 may be a force-sensitive resistor, strain gauge, piezoelectric or piezoresistive device, pressure sensor, or other suitable device. Force as utilized throughout the specification refers to force measurements, estimates, and/or calculations, such as pressure, deformation, stress, strain, force density, force-area relationships, thrust, torque, and other effects that include force or related quantities.

Force information related to a detected touch may be utilized to select information, such as information associated with a location of a touch. For example, a touch that does not meet a force threshold may highlight a selection option, whereas a touch that meets a force threshold may select or input that selection option. Selection options include, for example, displayed or virtual keys of a keyboard; selection boxes or windows, e.g., “cancel,” “delete,” or “unlock”; function buttons, such as play or stop on a music player; and so forth. Different magnitudes of force may be associated with different functions or input. For example, a lesser force may result in panning, and a higher force may result in zooming.

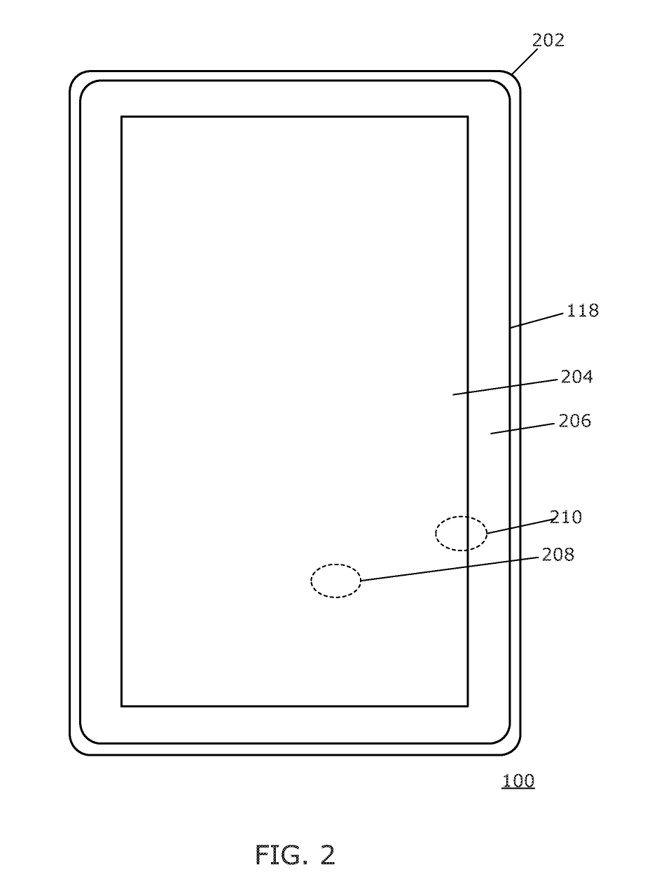

A front view of an example of the electronic device 100 is shown in FIG. 2. The electronic device 100 includes a housing 202 in which the touch-sensitive display 118 is disposed. The housing 202 and the touch-sensitive display 118 enclose components such as the components shown in FIG. 1. The display area 204 of the touch-sensitive display 118 may be generally centered in the housing 202. In this example, the non-display area 206 extends around the outer periphery of the display area 204. Other configurations are possible. For example, the non-display area may be wider or narrower and need not be equal in width on all sides. Further, the non-display area may extend around part of the display area 204 rather than extending around the entire display area.

The touch-sensitive overlay 114 includes electrodes that are utilized to detect touches and determine touch locations. Nodes, referred to herein as sensors, in a mutual capacitive touch-sensitive display are positions at which electrodes disposed in one layer of the touch-sensitive display 118 cross over electrodes disposed in another layer of the touch-sensitive display 118. The layers in which the electrodes are disposed are layers of a typical overlay that are separated by a substrate or other barrier. Changes in signals from the electrodes are caused by changes in mutual capacitance at sensors that are near a touch area. Sensors or electrodes that are referred to as being disposed in an area include sensors or electrodes that are operable to detect touches associated with that area. The changes in signals are detected at the controller 116 and utilized to determine a touch location. The change in signals when a touch is detected is referred to herein as touch data.

Touch locations may be determined based on touch data, such as relative changes in the signals from sensors that are associated with a touch area. Touch locations may be determined by sensors around the touch area. The area referred to herein as “around the touch area” may include the touch area and areas surrounding or outside of the touch area. Optionally, the area around the touch area may include the outer periphery of the touch area and areas surrounding the outer periphery of the touch area. Other areas may be considered to be around the touch area. The changes in signals, caused by changes in mutual capacitance at sensors around the touch area, are utilized to determine touch locations. To determine the touch location, for example, a location may be calculated utilizing data from each of the sensors around the touch area and the relative magnitude of change in mutual capacitance at each of the sensors around the touch area. Fewer than all of the sensors may be utilized, although a reduction in accuracy may result. For example, a touch location of a touch area 208 that is spaced from the edges of the display area 204, e.g., the area surrounding the touch area is completely within the display area 204, may be determined utilizing sensors disposed above, below, to the right, and to the left of the touch area 208. The terms above, below right, and left are utilized herein for reference only and refer to the orientation of the electronic device 100 as illustrated in FIG. 2 and are not otherwise limiting.

In prior devices, touch sensors are disposed in the display area, but are not disposed in the non-display area. The touch location determined for a touch that is near an edge of the display area 204, e.g., when the touch area is at least partially on the display area 204 and near or above the non-display area 206, may be less accurate than the touch location determined for a touch that is on the display area 204 and spaced from the edge of the display area 204. The decrease in accuracy of determination of the touch location for touch locations near a side of the display area 204 may be caused by a reduced number of sensors or a lack of sensors disposed in an area to at least one side of the touch area. Thus, the touch location is determined based on relative changes in signals from electrodes that do not include sensors located at least to one side of the touch area, e.g., the sensors are not located around the entire touch area. For example, the touch location of a touch area 210 may be determined utilizing sensors disposed above, below, and to the left of the touch area 210. Sensors are not located to the right of the touch area 210, and therefore fewer sensors may be utilized in prior devices.

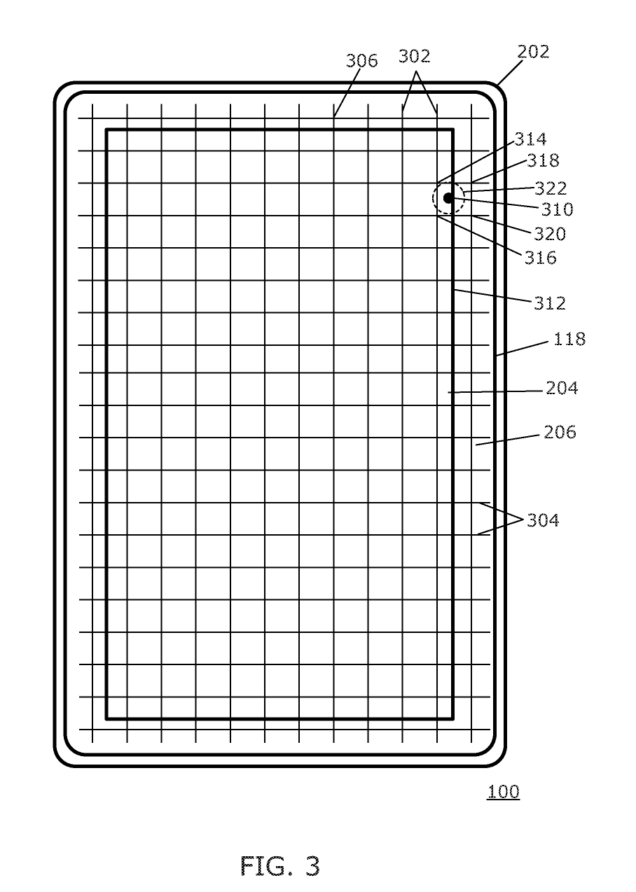

An example of touch sensors in accordance with the present disclosure is illustrated in FIG. 3. The touch-sensitive overlay 114 extends over the display area 204 and the non-display area 206. The touch-sensitive overlay 114 includes electrodes 302, 304 that extend across the display area 204 and the non-display area 206, and sensors 306 are located in both the display area 204 and the non-display area 206, such that a touch on either or both the display area 204 and the non-display area 206 may be detected. The density of the sensors disposed in the non-display area 206 may differ from the density of sensors disposed in the display area 204.

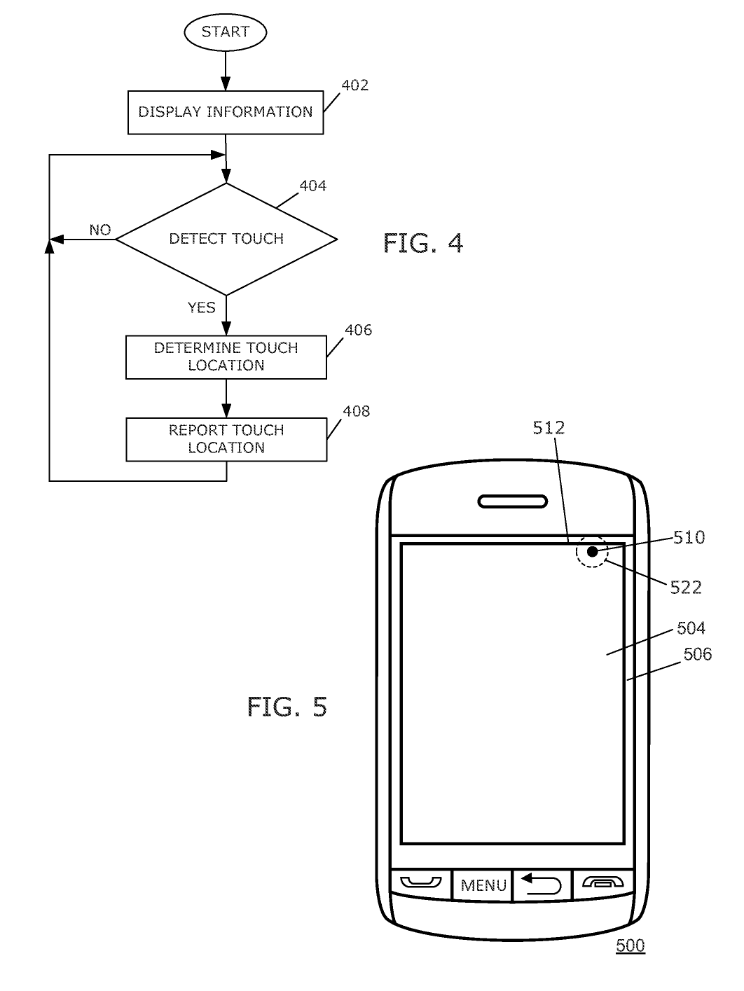

A flowchart illustrating a method of controlling an electronic device, such as the electronic device 100, is shown in FIG. 4. The method may be carried out by computer-readable code executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium. The method may be applied to any touch, including gestures and multi-touches in which at least two touches overlap at least partially in time.

Information is displayed 402 on the touch-sensitive display 118. The information may be information associated with a home screen, or any suitable application, such as email, text messaging, calendar, tasks, address book, Webpage, word processing, media, or any other suitable application in which information is displayed.

When a touch, including a touch near an edge of the display area 204, is detected 404, the touch location is determined 406. When a touch is detected near an edge of the display area 204, the relative changes in signals include relative changes caused by changes in mutual capacitance at sensors around the touch area. The sensors around the touch area include sensors in the display area 204 and sensors that are in the non-display area 206. Thus, the touch location is determined by interpolating between touch data including touch data from the display area 204 and touch data from the non-display area 206. The touch location is reported 408, for example, to the active application, or the application executed by the processor 102.

An example of a touch location that is near an edge of the display area 204 is illustrated by the circle 310 in FIG. 3, and the touch area is illustrated by the dashed line 322. The touch area 322 is near an edge 312 of the display area 204. The touch location is determined by interpolating between touch data from changes in mutual capacitance at the sensors around the touch area, including the sensors 314, 316 disposed in the display area 204 and the sensors 318, 320 disposed in the non-display area 206. The touch location is reported to the processor 102.

In the example described above, the touch location is determined utilizing touch data from the display area 204 and touch data from the non-display area 206 of the touch-sensitive display 118. The touch location determined from both the display area and the non-display area may be utilized in identifying gestures. Locations of one or more touches that overlap at least partially in time may also be determined from the display area 204 and touch data from the non-display area 206.

A touch on a touch-sensitive display of another example of a portable electronic device 500 is illustrated in FIG. 5. The touch-sensitive display of the electronic device 500 includes a display area 504 and a non-display area 506. An example of a touch location that is near an edge 512 of the display area 504 is illustrated by the circle in FIG. 3. The touch location is determined by interpolating between touch data from the sensors around the touch area 522, including sensors disposed in the display area 504 and sensors disposed in the non-display area 506.

Utilizing touch data from the display area and touch data from the non-display area, the location of a touch that is at or near an edge of the display area may be determined with greater accuracy and less noise. The location of the touch may be determined by interpolating between touch data from the display area and touch data from the non-display area. Accuracy of touch locations at or near an edge of the display area, which may be near a side of touch-sensitive display, is improved because more data is available, which data is sourced by more sensors around a touch area. Accuracy of touch data is consistent for touch locations that are away from an edge of the display area and touch locations that are at or near an edge of the display area. Touch data is more accurate for touch locations at or near an edge than touch data provided by devices not utilizing touch sensors in a non-display area. The method described herein may be applied to methods other than interpolation methods and methods that include interpolation and non-interpolation methods.

A method includes displaying information in a display area of a touch-sensitive display, receiving touch data from the display area and touch data from a non-display area where information is not displayed, and determining a touch location in the display area based on the touch data from the display area and the touch data from the non-display area.

An electronic device includes a touch-sensitive display including a display area where information is displayable and a non-display area where information is not displayable, and a processor coupled to the touch-sensitive display to receive touch data from the display area and touch data from the non-display area, and determine a touch location in the display area based on the touch data from the display area and the touch data from the non-display area.

An electronic device includes a touch-sensitive display including a display area where information is displayable, a non-display area where information is not displayable, and touch sensors including display area sensors disposed in the display area and non-display area sensors disposed in the non-display area. A processor is coupled to the touch-sensitive display to receive touch data from a plurality of the touch sensors. Accuracy of touch data is consistent for touch locations away from an edge of a display area and touch locations at an edge of the display area.

The present disclosure may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. A method comprising:
displaying information in a display area of a touch-sensitive display;
receiving touch data from the display area and touch data from a non-display area where information is not displayed;
determining a touch location in the display area based on the touch data from the display area and the touch data from the non-display area.

2. The method according to claim 1, wherein the touch location is near an edge of the display area.

3. The method according to claim 1, wherein the non-display area extends around a periphery of the display area.

4. The method according to claim 1, wherein determining the touch location comprises interpolating between the touch data from the display area and the touch data from the non-display area.

5. The method according to claim 1, wherein determining the touch location comprises calculating the location based on relative changes in signals from electrodes of the touch-sensitive display, including at least one electrode in the non-display area.

6. The method according to claim 1, wherein determining the touch location comprises calculating the location based on relative changes in signals from electrodes of the touch-sensitive display, including at least one sensor disposed in the display area and at least one sensor disposed in the non-display area.

7. A computer-readable medium having computer-readable code executable by at least one processor of the electronic device to perform the method of claim 1.

8. An electronic device comprising:
a touch-sensitive display including a display area where information is displayable and a non-display area where information is not displayable;
a processor coupled to the touch-sensitive display to receive touch data from the display area and touch data from the non-display area, and determine a touch location in the display area based on the touch data from the display area and the touch data from the non-display area.

9. The electronic device according to claim 8, wherein touch-sensing electrodes of the touch-sensitive display are disposed in the non-display area.

10. The electronic device according to claim 8, wherein touch sensors of the touch-sensitive display are disposed in the non-display area.

11. The electronic device according to claim 8, wherein the touch location is near an edge of the display area.

12. The electronic device according to claim 8, wherein the non-display area extends around a periphery of the display area.

13. The electronic device according to claim 8, wherein the touch location is determined by interpolating between the touch data from the display area and the touch data from the non-display area.

14. The electronic device according to claim 8, wherein the touch location is determined by calculating the location based on relative changes in signals from electrodes of the touch-sensitive display, including at least one electrode in the non-display area.

15. The electronic device according to claim 8, wherein the touch location is determined by calculating the location based on relative changes in signals from electrodes of the touch-sensitive display, including at least one sensor disposed in the display area and at least one sensor disposed in the non-display area.

16. An electronic device comprising:
a touch-sensitive display including:
a display area where information is displayable;
a non-display area where information is not displayable;
touch sensors including display area sensors disposed in the display area and non-display area sensors disposed in the non-display area;
wherein accuracy of touch data is consistent for touch locations away from an edge of a display area and touch locations at or near an edge of the display area.

17. The electronic device according to claim 16, wherein the touch data includes data from the non-display area sensors for the touches at the edge of the display area.

18. The electronic device according to claim 16, wherein the touch sensors comprise positions at which electrodes disposed in a first layer of the touch-sensitive display cross over electrodes disposed in a second layer of the touch-sensitive display.

19. The electronic device according to claim 16, wherein the touch locations at the edge of the display area are determined by interpolating between touch data from the touch sensors disposed around the touch locations at the edge of the display area.

20. The electronic device according to claim 16, wherein the touch locations at the edge of the display area are determined by interpolating between touch data from the display area sensors and at least one of the non-display area sensors.
